(19) United States
(12) Patent Application Publication
(10) Pub. No.: US 2020/0132625 A1
(43) Pub. Date: Apr. 30, 2020

(54) ANALYSIS METHOD FOR COMPOUND HAVING POLYOXYALKYLENE GROUP IN SAMPLE

(71) Applicant: AGC Inc., Chiyoda-ku (JP)

(72) Inventors: Toshifumi Kakiuchi, Chiyoda-ku (JP); Kei Ishitsuka, Chiyoda-ku (JP); Shun Saito, Chiyoda-ku (JP); Eisuke Murotani, Chiyoda-ku (JP); Toshio Nakashima, Chiyoda-ku (JP)

(73) Assignee: AGC Inc., Chiyoda-ku (JP)

(21) Appl. No.: 16/727,019

(22) Filed: Dec. 26, 2019

Related U.S. Application Data
(63) Continuation of application No. PCT/JP18/24643, filed on Jun. 28, 2018.

(30) Foreign Application Priority Data
Jun. 28, 2017 (JP) 2017-126479

(51) Int. Cl. G01N 27/62; H01J 49/00; H01J 49/04

(52) U.S. Cl. CPC G01N 27/62; H01J 49/0418; H01J 49/0031

(57) ABSTRACT

Provided is an analysis method capable of promptly providing information for determining whether a compound having a polyoxyalkylene group is contained in a sample such as a coating material or a coating film. The analysis method includes directly analyzing a sample such as a coating material or a coating film formed from the coating material by a matrix-assisted laser desorption/ionization method or a DART method to provide information for determining whether a compound having a polyoxyalkylene group, such as alkylphenol ethoxylate, is contained in the sample.

### TECHNICAL FIELD

The present invention relates to a method for analyzing a sample, such as a coating material or a coating film formed from the coating material, to provide information for determining whether a compound having a polyoxyalkylene group is contained in the sample.

### BACKGROUND ART

To date, compounds having a polyoxyalkylene group have been used as surfactants in various applications and are often used in coating materials. Recently, some of the compounds have caused concern about their environmental load and, in order to suppress the discharge of the compounds having a polyoxyalkylene group into the environment, there has been a growing need to promptly determine the presence or absence of the compounds in a coating material or a coating film formed from the coating material.

Patent Document 1 discloses an analysis method for a nonionic surfactant in a nonionic surfactant-containing solution containing polyoxyethylene glycol mono-p-alkylphenyl ether wherein, first, the nonionic surfactant-containing solution is concentrated by solid phase extraction, and then the concentrate concentrated by solid phase extraction is analyzed with a reverse phase high performance liquid chromatograph equipped with a fluorescence detector.

### PRIOR ART DOCUMENTS

### Patent Document

Patent Document 1: JP-A-H06-102267

### DISCLOSURE OF INVENTION

### Technical Problem

The present inventors examined whether the analysis method described in Patent Document 1 is capable of providing information for determining whether a compound having a polyoxyalkylene group is contained in a coating material or a coating film formed from the coating material, and found that the operation is troublesome, also, the time from the extraction treatment to the acquisition of information is long, and it was not possible to promptly determine the presence or absence of the specific compound.

Accordingly, an object of the present invention is to provide an analysis method capable of promptly providing information for determining whether a compound having a polyoxyalkylene group is contained in a sample such as a coating material or a coating film formed from the coating material.

### Solution to Problem

As a result of having conducted intensive studies to accomplish the above object, the inventors found that the object can be accomplished, and the present invention has the following aspects.

[1] A method for analyzing whether a compound having a polyoxyalkylene group is contained in a sample, the method comprising directly analyzing the sample by a matrix-assisted laser desorption/ionization method or a DART method to provide information for determining whether the compound having a polyoxyalkylene group is contained.

[2] The method according to [1], wherein the sample is a coating material or an extract of a coating film formed from the coating material.

[3] The method according to [2], wherein the coating material is an aqueous coating material containing a fluorinated polymer, water, and the compound having a polyoxyalkylene group, the fluorinated polymer has a unit based on fluoroolefin, and the fluoroolefin is at least one selected from the group consisting of CF₂═CF₂, CF₂═CFCF₃, CF₂═CFCl, CF₂═CH₂, CF₃—CH═CHF, and CF₃—CF═CH₂.

[4] The method according to [3], wherein the fluorinated polymer has a unit based on a monomer other than the fluoroolefin and copolymerizable with the fluoroolefin.

[5] The method according to [3], wherein the fluorinated polymer further has a unit having a hydrophilic group.

[6] The method according to any one of [1] to [5], wherein the sample has a content of the compound having a polyoxyalkylene group of 0.0001 to 10 mass %.

[7] The method according to any one of [1] to [6], wherein the compound having a polyoxyalkylene group has a molecular weight of 10,000 or less.

[8] The method according to any one of [1] to [7], wherein the compound having a polyoxyalkylene group is a compound represented by formula (1) below:

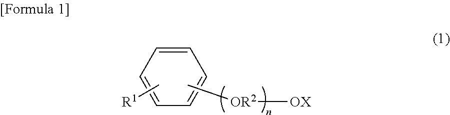

wherein R¹ represents an alkyl group having 1 to 40 carbon atoms, R² represents an alkylene group having 2 to 4 carbon atoms, n represents an integer of 2 or more, and X represents H, SO₃⁻Na⁺, or SO₃⁻NH₄⁺.

[9] The method according to [8], wherein the compound represented by formula (1) is alkylphenol ethoxylate.

[10] The method according to [9], wherein the compound represented by formula (1) is nonylphenol ethoxylate or octylphenol ethoxylate.

[11] The method according to any one of [1] to [10], wherein the sample contains perfluorocarboxylic acid as a contaminant, and the method also provides information for determining whether the perfluorocarboxylic acid is contained.

[12] The method according to [11], wherein the perfluorocarboxylic acid is perfluorooctanoic acid.

### Advantageous Effects of Invention

The present invention can provide a method capable of promptly providing information for determining whether a compound having a polyoxyalkylene group, e.g., nonylphenol ethoxylate, is contained in a sample such as a coating material or a coating film thereof even without performing any of the separation and purification treatments and even when an analysis is performed without removing contaminants.

### BRIEF DESCRIPTION OF DRAWINGS

FIG. 1 shows the results of analysis by a matrix-assisted laser desorption/ionization method in Example 5;

FIG. 2 shows the results of analysis by a DART method in Example 6; and

FIG. 3 shows the results of analysis by a matrix-assisted laser desorption/ionization method in Example 9.

### DESCRIPTION OF EMBODIMENTS

The terms used herein have the following meanings.

The numerical range indicated by “to” means a range including the numerical values set forth before and after “to” as a lower limit and an upper limit, respectively.

“(Meth)acrylate” is a generic term referring to both “acrylate” and “methacrylate”, and “(meth)acryl” is a generic term referring to both “acryl” and “methacryl”.

The “unit” is a generic term referring to both a group of atoms formed directly by polymerization of a monomer and based on one molecule of the monomer and a group of atoms obtained by chemically converting a part of the aforementioned group of atoms. The content (mol %) of each unit based on all units contained in a polymer is determined by analyzing the polymer by nuclear magnetic resonance spectrometry.

The “number average molecular weight” is a value measured by gel permeation chromatography (GPC) in which polystyrene is used as a standard substance. The “number average molecular weight” is also referred to as “Mn”.

First, when described in reference to a coating material or an extract of a coating film or the like formed from the coating material, which is a preferable, typical sample in the present invention, the present analysis method is a method for providing information for determining whether a compound having a polyoxyalkylene group is contained in the sample by directly analyzing the sample by a matrix-assisted laser desorption/ionization (MALDI) method or a direct analysis in real time (DART) method.

A compound having a polyoxyalkylene group (hereinafter also referred to as a specific compound) is often used as a surfactant and, in such a case, the content of the specific compound in a sample is, generally, significantly smaller than the contents of other components contained in the sample. Moreover, the sample often contains other surfactants having structures different from that of the specific compound.

In such a case, in order to determine whether the specific compound is contained in a sample, it was thought necessary to separate/remove components other than the specific compound contained in the sample (such as other surfactants, which are also referred to as contaminants below) by solid phase extraction or high performance liquid chromatography and then obtain information concerning the content of the specific compound (such as a total ion chromatogram, a mass chromatogram, or a mass spectrum), as described in Patent Document 1 above. Contaminants in particular are usually dissolved or dispersed in the sample, and the operation of separating the contaminants is troublesome.

As a result of having conducted intensive studies to meet the need for promptly determining whether the specific compound is contained in the sample, the present inventors found that the specific compound is specifically ionized in a highly efficient manner when a matrix-assisted laser desorption/ionization method or a DART method (hereinafter these methods are collectively referred to as a specific ionization method) is used, and accomplished the present invention.

The present analysis method is an analysis method that takes advantage of the specific characteristics of the specific compound and directly analyzes the sample, or in other words, analyzes the sample without performing any of the separation and purification treatments, or further in other words, analyzes the sample without removing contaminants, to provide information for determining whether the specific compound is contained in the sample. At this time, the ionization efficiency of the contaminants by the specific ionization method is poor, and thus the contaminants do not affect provision of information for determining whether the specific compound is contained.

Below, the procedure and the like of the present analysis method will now be described in detail.

In the present analysis method, a coating material as-is, or an extract obtained by performing an extraction treatment on a coating film formed from the coating material, is preferably used as a sample. The coating material or the coating film formed from the coating material is expected to contain the specific compound, at least a part of the specific compound is expected to be an environmentally concerned substance, and, moreover, the coating material or the coating film usually contains various contaminants. Therefore, the present analysis method is particularly useful for promptly determining whether the specific compound is contained.

As long as the coating material is a liquid or a mixture of a liquid and a solid, the coating material can be used as a sample without performing any of the extraction, separation, and purification treatments.

The coating film formed from the coating material can be used as a sample by bringing the coating film into contact with a solvent and collecting the contacted solvent to obtain an extract, or by rubbing the coating film with the solvent-soaked tip of a cotton swab to adhere an extract to the tip of the cotton swab.

The coating material or the extract may be subjected to solid-liquid separation as necessary.

The solvent used in extraction is preferably a solvent that dissolves the specific compound, and examples include polar solvents and, more specifically, alcohols such as methanol. Two or more solvents may be used in combination.

The present analysis method can provide information for determining the presence or absence of the specific compound in a sample by using the specific ionization method without performing any of the separation and purification treatments on a sample. Naturally, separation and purification may be performed in the present analysis method as necessary. Herein, examples of separation and purification include solid phase extraction and high performance liquid chromatography.

The MALDI method is a method involving irradiating a mixture of a sample and a matrix (such as α-cyano-4-hydroxycinnamic acid) with a laser to cause the matrix to absorb the energy of the irradiated laser, evaporate the components of the sample together with the matrix, moreover, cause proton transfer between the matrix and the components, and thus ionize the measurement target substance.

An example of a commercially available apparatus capable of performing the MALDI method may be AXIMA-CFR plus manufactured by Shimadzu Corporation.

In the present invention, the MALDI method is preferable especially because the molecular weight range of the measurement target substance is broad.

The DART method is a method involving applying excitation gas to a sample in an atmospheric environment to induce an interaction between molecules in the atmosphere (water molecules in particular) and the components in the sample and ionize the components.

An example of a method for ionizing the specific compound by the DART method is a method involving holding a sample-adhered cotton swab or glass rod at a DART ion source. A commercially available DART ion source may be an apparatus manufactured by Ionsense Inc.

In the present analysis method, the specific compound ionized by the specific ionization method is typically introduced into a mass spectrometer and analyzed. Specific examples of mass spectrometers include time-of-flight, ion trap, quadrupole, magnetic field, and Fourier transform ion cyclotron resonance mass spectrometers, and two or more units of such a mass spectrometer may be used, or two or more such mass spectrometers may be used in combination.

In particular, a time-of-flight mass spectrometer, an arrangement in which two or more time-of-flight mass spectrometers are used, and an arrangement in which a time-of-flight mass spectrometer and another mass spectrometer are used in combination are preferable because the mass can be precisely analyzed.

The analysis method in which the specific compound ionized by the MALDI method is then introduced into a mass spectrometer and analyzed is also referred to as a “MALDI/TOFMS method” in particular. Similarly, the analysis method in which the specific compound ionized by the DART method is then introduced into a mass spectrometer and analyzed is also referred to as a “DART-MS method”.

The present analysis method can be applied to various coating materials and extracts of coating films formed from the coating materials without limitation.

A preferable aspect of a coating material to be subjected to the present analysis method is a coating material containing the specific compound and a fluorinated polymer (hereinafter, also referred to as a specific polymer) having a fluoroolefin-based unit (hereinafter also referred to as “unit F”), and a more preferable aspect is an aqueous coating material containing the specific polymer, water, and the specific compound (hereinafter also referred to as a specific coating material). When the present analysis method is applied to the specific coating material and a coating film formed from the specific coating material, the specific polymer is unlikely detected by the present analysis method and, thus, the specific compound can be detected more sensitively.

Fluoroolefin is an olefin having one or more of hydrogen atoms replaced by fluorine atoms. In fluoroolefin, one or more of hydrogen atoms not replaced by fluorine atoms may be replaced by chlorine atoms.

Specific examples of fluoroolefin include at least one selected from the group consisting of CF₂═CF₂ (TFE), CF₂═CFCF₃ (HFP), CF₂═CFCl (CTFE), CF₂═CH₂ (VDF), CF₃—CH═CHF, and CF₃—CF═CH₂. Two or more kinds of fluoroolefin may be used in combination.

The specific polymer may be composed solely of unit F, or may have a unit (hereinafter also referred to as “unit 1”) other than unit F.

Examples of the specific polymer composed solely of unit F include a fluoroolefin homopolymer and a copolymer of two or more kinds of fluoroolefin. Specific examples include polytetrafluoroethylene, polychlorotrifluoroethylene, a copolymer of TFE and HFP, and a copolymer of TFE, VDF and CTFE.

The content of unit F based on all units contained in the specific polymer is preferably 5 to 100 mol %. In the case of the specific polymer having unit F and unit 1, the specific compound is likely incorporated into the specific polymer when the content of unit 1 is 20 to 70 mol % and, in particular, 40 to 60 mol %. Accordingly, the concentration of the specific compound in the extract is likely lowered, and thus an analysis of the specific compound is likely difficult. However, the present analysis method is capable of suitably performing an analysis for the specific compound even in such a case.

When the specific polymer has unit 1, unit 1 is a unit based on a monomer other than fluoroolefin and copolymerizable with fluoroolefin (hereinafter also referred to as monomer 1). When unit 1 is a unit not having a fluorine atom, the present analysis method is more preferable in view of detection sensitivity.

Examples of monomer 1 include alkene, vinyl ether, vinyl ester, allyl ether, allyl ester, and (meth)acrylic acid ester. Specific examples include ethylene, propylene, ethyl vinyl ether, tert-butyl vinyl ether, 2-ethylhexyl vinyl ether, cyclohexyl vinyl ether, vinyl acetate, pivalic acid vinyl ester, neononanoic acid vinyl ester (trade name “VeoVa 9” of HEXION), neodecanoic acid vinyl ester (trade name “VeoVa 10” of HEXION), benzoic acid vinyl ester, methyl (meth)acrylate, and butyl (meth) acrylate.

Unit 1 may have a hydrophilic group. Unit 1 having a hydrophilic group may be a unit based on monomer 1 having a hydrophilic group, or may be a unit obtained by converting a functional group in unit 1, which can be converted into a hydrophilic group, into a hydrophilic group.

When unit 1 has a hydrophilic group, the specific polymer and the specific compound likely have affinity for each other, thus the concentration of the specific compound in the extract is likely lowered, and an analysis of the specific compound is likely difficult. However, the present analysis method is capable of suitably performing an analysis for the specific compound even in such a case.

Examples of the hydrophilic group in monomer 1 include a hydroxy group, a carboxy group, a hydrolyzable silyl group, and an amino group.

Specific examples of monomer 1 having a hydrophilic group include cyclohexane dimethanol monovinyl ether, 2-hydroxyethyl vinyl ether, 4-hydroxybutyl vinyl ether, diethylene glycol monovinyl ether, hydroxyethyl allyl ether, hydroxyethyl carboxylic acid vinyl ester, hydroxyethyl (meth)acrylate, (meth)acrylic acid, and carboxylic acid.

Monomer 1 may have a polyoxyalkylene group. Note that, as will be described below, the specific polymer is not included in the specific compound, and thus in the case where the specific polymer has a polyoxyalkylene group as well, the specific polymer is not regarded as the specific compound. This is because even when the specific polymer has a unit based on a monomer having a polyoxyalkylene group, the specific polymer is unlikely detected in the present analysis method, and thus a polyoxyalkylene group derived from the specific polymer is barely detected. Monomer 1 may have a crosslinkable group such as an isocyanate group, an epoxy group, or an oxetanyl group. Two or more kinds of monomer 1 may be used in combination.

The specific polymer is usually obtained by, for example, a method involving obtaining a polymer by an emulsion polymerization method, a suspension polymerization method, or a solution polymerization method, then removing the organic solvent, and redispersing or dissolving the polymer in water.

The specific polymer may be a core-shell polymer in which the polymer having unit F serves as a core part, and the polymer having unit 1 serves as a shell part.

The content of unit 1 based on all units contained in the specific polymer is usually 0 to 95 mol %. The Mn of the specific polymer is usually 5,000 to 2,000,000.

Examples of the specific compound contained in a sample include an addition reaction product between alkylphenol and alkylene oxide, a condensate between polyalkylene glycol or a polyalkylene glycol derivative and a compound having a functional group capable of condensation with a hydroxy group, or a salt thereof. The salt may be sulfate or the like.

A polymer having unit F is not included in the specific compound. That is to say, the specific polymer is not included in the specific compound.

Polyalkylene glycol has an oxyalkylene unit. Specific examples of the oxyalkylene unit include an oxyethylene unit and an oxypropylene unit. The alkylene group in the oxyalkylene group may be linear or branched.

Polyalkylene glycol may have a hydroxy group at least one terminal or may have a hydroxy group at both terminals.

The degree of polymerization of polyalkylene glycol is usually 2 to 300 and may have two or more kinds of units. In this case, polyalkylene glycol may be a block copolymer or a random copolymer.

Specific examples of the functional group capable of condensation with a hydroxy group include a carboxy group, a hydroxy group, and an amino group.

Specific examples of the specific compound include an ester obtained by condensing polyalkylene glycol and carboxylic acid, an ether obtained by condensing polyalkylene glycol and alcohol or alkylphenol, and sulfates thereof.

Specific examples of the carboxylic acid include saturated aliphatic carboxylic acids (such as formic acid, acetic acid, propionic acid, butyric acid, valeric acid, caproic acid, enanthic acid, caprylic acid, pelargonic acid, capric acid, lauric acid, myristic acid, palmitic acid, margaric acid, and stearic acid), unsaturated aliphatic carboxylic acids (such as acrylic acid, methacrylic acid, oleic acid, linoleic acid, linolenic acid, arachidonic acid, docosahexaenoic acid, and eicosapentaenoic acid), and polycarboxylic acids (such as polymers of acrylic acid, methacrylic acid, and the like).

Specific examples of the alcohol include saturated aliphatic monoalcohols (such as methanol, ethanol, isopropyl alcohol, erucyl alcohol, lisinolyl alcohol, arachidyl alcohol, capryl alcohol, behenyl alcohol, lauryl alcohol, myristyl alcohol, palmityl alcohol, and stearyl alcohol), unsaturated aliphatic monoalcohols (such as oleyl alcohol, linoleyl alcohol, elaidyl alcohol, and linolenyl alcohol), polyalcohols (such as sorbit and sorbitol), and aromatic alcohols.

Specific examples of the alkylphenol include nonylphenol and octylphenol.

Specific examples of the amine include primary monoamines (such as ethanolamine, oleylamine, and stearylamine) and secondary monoamines (such as diethanolamine).

The specific compound may be a condensate between polyalkylene glycol and a compound having a functional group capable of condensation with a plurality of hydroxy groups. The specific compound may have two or more kinds of polyoxyalkylene groups.

The molecular weight of the specific compound is not particularly limited, and is preferably 10,000 or less, more preferably 3,000 or less, and particularly preferably 2,000 or less. The molecular weight of the specific compound is preferably 80 or more.

Specific examples of the specific compound include polyoxyalkylene alkylphenol ether, polyoxyalkylene ether sulfate, triethanolamine polyoxyalkylene ether sulfate, polyoxyalkylene monoalkyl ether, polyoxyethylene-polyoxypropylene alkyl ether, polyoxyethylene methyl glucoside, polyoxyalkylene cholesteryl ether, polyoxyethylene ester, polyoxyalkylene diester, and polyoxyethylene alkyl ether ester.

From the viewpoint that the present analysis method can be applied particularly effectively, the specific compound is preferably a compound represented by formula (1) below (hereinafter, also referred to as “compound 1”). In formula (1), R¹ represents an alkyl group having 1 to 40 carbon atoms, R² represents an alkylene group having 2 to 4 carbon atoms, n represents an integer of 2 or more, and X represents H, SO₃⁻Na⁺, or SO₃⁻NH₄⁺.

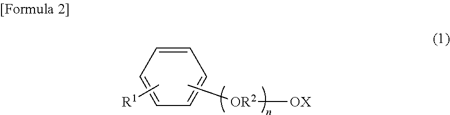

Specific examples of compound 1 include compounds represented by formula (1-1) below. The characters in formula (1-1) are synonymous with the characters in formula (1).

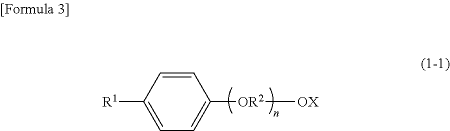

Specific examples of compound 1 include nonylphenol ethoxylate (also known as poly(oxyethylene) nonylphenyl ether) and octylphenol ethoxylate (also known as poly(oxyethylene) octylphenyl ether).

Nonylphenol ethoxylate is a regulated substance because it degrades over time to discharge nonylphenol, which is an environmentally concerned substance, and, accordingly, whether nonylphenol ethoxylate is contained in a sample, particularly in a coating material or a coating film thereof, needs to be promptly determined. The present analysis method specifically detects a peak derived from the polyoxyalkylene group of nonylphenol ethoxylate and peaks derived from other residues, and thus can promptly provide information for determining whether nonylphenol ethoxylate is contained in a coating material or a coating film thereof.

In view of the detection sensitivity and the accuracy of the present analysis method, the content of the specific compound in the specific coating material is preferably 0.0001 mass % or more and more preferably 0.001 mass % or more based on the total mass of the specific coating material. The present analysis method can provide information concerning the presence or absence of the specific compound even when the content of the specific compound in the specific coating material is extremely small, such as 0.0001 mass % or 0.001 mass %. The content is usually 10 mass % or less.

The present analysis method can detect the specific compound particularly highly sensitively when the content of the specific compound in the specific coating material is preferably 0.0001 to 10 mass %, more preferably 0.001 to 8 mass %, and particularly preferably 0.01 to 5 mass %. The content of the specific polymer in the specific coating material is usually 20 to 80 mass %.

The specific coating material may contain contaminants (components other than the specific polymer and the specific compound). The present analysis method can suitably analyze the specific compound even when contaminants are contained in the specific coating material.

Specific examples of the contaminants include polymers other than the specific polymer (such as acrylic resin, polyester resin, urethane resin, and epoxy resin), and a surfactant, a curing agent, a pigment, a dispersant, a defoamer, a coalescing aid, a leveling agent, a thickener, a curing aid, a light stabilizer, a UV absorber, and a surface conditioner that do not have a polyoxyalkylene group.

When the specific coating material contains the specific polymer, the specific compound, and water, water is a dispersion medium for dispersing the specific polymer in the specific coating material. The dispersion medium may be composed solely of water or a mixed solvent of water and a water-soluble organic solvent. Specific examples of the water-soluble organic solvent include methanol, ethanol, butanol, acetone, and methyl ethyl ketone.

The coating film formed from the specific coating material (hereinafter also referred to as a specific coating film) may be formed by directly applying the specific coating material to the surface of a substrate, may be formed by applying the specific coating material to the surface of a substrate that has been subjected to a surface treatment (such as surface preparation), or may be formed by applying the specific coating material to the surface of a substrate having a resin layer (such as a polyester resin layer, an acrylic resin layer, an epoxy resin layer, or a urethane resin layer) on the surface.

The concentration (content) of the specific compound contained in the specific coating film is preferably 0.001 mass % or more, and more preferably 0.01 mass % or more, in view of the detection sensitivity of the present analysis method. The present analysis method can provide information for determining whether the specific compound is contained even when the content of the specific compound in the specific coating film is extremely small such as 0.001 mass % or 0.01 mass %. The content is usually 20 mass % or less.

The present analysis method can detect the specific compound particularly highly sensitively when the content of the specific compound in the specific coating film is 0.001 to 20 mass %, more preferably 0.01 to 0.10 mass %, and particularly preferably 0.1 to 5 mass %. The content of the specific polymer in the specific coating film is usually 50 to 99 mass %.

Information for determining whether the specific compound is contained, which is obtained by the present analysis method, is mass spectrum data that may be output on a paper medium or shown on a display device.

While the present analysis method has been described above in reference to the case where the target sample is a coating material or a coating film thereof, the present analysis method is similarly applicable to samples containing a compound having a polyoxyalkylene group.

Such samples are not particularly limited, and examples include agrochemicals, fertilizers, dyes, pigments, pharmaceuticals, cosmetics, fragrances, machine oils, fibers, paper, and pulp. Also, the form of a sample is not particularly limited, and may be any of a liquid, a mixture of a liquid and a solid, and a solid extract. The matrix-assisted laser desorption/ionization method or the DART method, other operations concerning a sample preparation method and the like, as well as the effects of the invention are the same as the present analysis method.

In particular, the present analysis method can promptly provide information concerning whether nonylphenol ethoxylate, which is an environmentally concerned substance, is contained in a sample, and can contribute to conservation of the global environment.

Moreover, when the target sample contains, in addition to a compound having a polyoxyalkylene group, perfluorocarboxylic acid represented by perfluorooctanoic acid, which is an environmentally concerned substance, the present analysis method can also detect this substance.

Perfluorooctanoic acid is barely degradable, it is thus desirable to reduce its use, and there is an increased global interest concerning the presence or absence of perfluorooctanoic acid in a sample. The present analysis method can determine a peak derived from perfluorooctanoic acid among the small peaks derived from contaminants that do not affect the detection of a compound having a polyoxyalkylene group.

Accordingly, the present analysis method can further verify the presence or absence of perfluorooctanoic acid after promptly verifying the presence or absence of a compound having a polyoxyalkylene group in a sample and, therefore, the present analysis method can verify the presence or absence of multiple environmentally concerned substances in a single analysis and thus has excellent analysis efficiency.

As described above, the present analysis method can promptly provide information for determining whether environmentally concerned substances (such as nonylphenol ethoxylate, octylphenol ethoxylate, diethylene glycol dimethyl ether, and triethylene glycol dimethyl ether, in particular) are contained and, thus, can greatly contribute to environmental conservation activities and the reduction of environmentally concerned substances.

### EXAMPLES

Below, the present invention will now be described in detail by way of examples, but the present invention is not limited to these examples.

### Example 1

Tetrafluoroethylene (TFE), hexafluoropropylene (HFP), methyl methacrylate (MMA), and VeoVa 9 (V9) were used as monomers and polymerized in water as a polymerization solvent in the presence of nonylphenol ethoxylate (NPE) to give aqueous dispersion 1 containing fluorinated polymer 1 (a fluorinated polymer concentration of 50 mass %, a NPE concentration of 0.05 mass %). Fluorinated polymer 1 was a polymer having a unit derived from TFE in an amount of 46 mol %, a unit derived from HFP in an amount of 4 mol %, a unit derived from MMA in an amount of 25 mol %, and a unit derived from V9 in an amount of 25 mol % based on all units contained in fluorinated polymer 1.

### Example 2

Aqueous dispersion 2 containing fluorinated polymer 2 (a fluorinated polymer concentration of 50 mass %, a PA concentration of 0.05 mass %) was obtained in the same manner as in Example 1 except that sodium polycarboxylate (PA) (Charol AN-103P (trade name), manufactured by DKS Co., Ltd.) was used in place of NPE.

### Example 3

Pigment (D918 (manufactured by Sakai Chemical Industry Co., Ltd.)) (86 g), a dispersant (BYK-190 (manufactured by BYK-Chemie)) (6 g), and defoamer 1 (Dehydran 1620 (manufactured by BASF)) (0.6 g) were mixed to give a mill base.

Then, aqueous dispersion 1 (63 g), mill base (22 g), a coalescing aid (CS-12 (manufactured by Aldrich)) (4.4 g), a thickener (Rheolate 288 (manufactured by Elementis Plc)) (0.09 g), defoamer 2 (manufactured by BYK-028 (BYK-Chemie)) (0.25 g), and ion-exchanged water (2.6 g) were mixed to give aqueous coating material 1.

Aqueous coating material 2 was obtained in the same manner as above except that aqueous dispersion 2 was used in place of aqueous dispersion 1.

### Example 4

SK Clear Sealer (manufactured by SK Kaken Co., Ltd.) was applied with an applicator to the surface of an Alodine-treated aluminum plate having a length of 120 mm, a width of 60 mm, and a thickness of 15 mm so as to have a dry film thickness of 10 and dried at 80° C. for 210 seconds to form an undercoat film.

Then, aqueous coating material 1 was applied with an applicator to the surface of the undercoat film so as to have a dry film thickness of 40 μm, and cured at 23° C. for 2 weeks to give substrate 1 having a coating film formed from aqueous coating material 1 (a NPE concentration in the coating film of 0.1 mass %).

Moreover, substrate 2 having a coating film formed from aqueous coating material 2 (a PA concentration in the coating film of 0.1 mass %) was obtained in the same manner except that aqueous coating material 2 was used in place of aqueous coating material 1.

### Example 5

After 100 μL of methanol was added dropwise to the coating film surface of substrate 1, the substrate was left to stand still for 1 minute, and then the added methanol was recovered. The recovered methanol was regarded as extract 1.

Extract 2 was obtained in the same manner except that substrate 2 was used in place of substrate 1.

A mixed solution obtained by mixing equal amounts of extract 1 and extract 2 (0.5 μL), a 1 mass % methanol solution of sodium iodide (0.5 μL), and a 1 mass % methanol solution of α-cyano-4-hydroxycinnamic acid (0.5 μL) were added dropwise in this order to a mass spectrometry plate, and analyzed by a MALDI/TOFMS method using AXIMA-CFR plus (manufactured by Shimadzu Corporation).

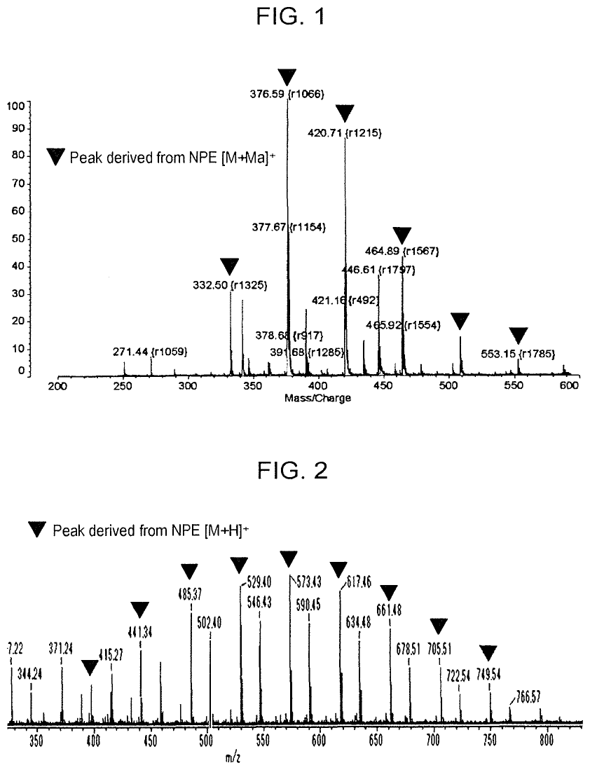

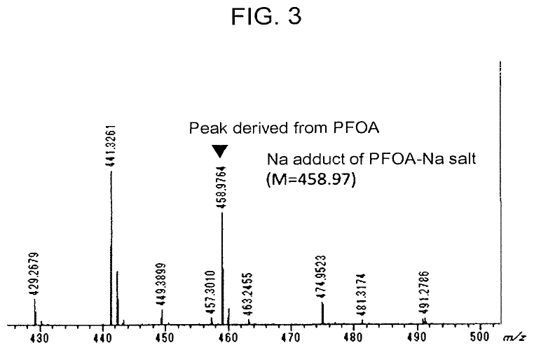

The analysis results are shown in FIG. 1. In FIG. 1, the vertical axis represents detection intensity, and the horizontal axis represents m/z (the ratio of mass m to charge z). The same applies to FIGS. 2 and 3 described below. In FIG. 1, the peak indicated by ▾ is a peak derived from NPE. That is, the peak indicated by ▾ is detected at m/z intervals of about 44, and is thus information from which the mixture of extract 1 and extract 2 can be determined as containing a compound having a polyoxyalkylene group (a polyoxyethylene group). It is also possible from the resulting information to identify the detected compound as NPE in reference to a known library or the like.

### Example 6

The methanol-soaked tip of a cotton swab was rubbed back and forth twice against both substrate 1 and substrate 2 to obtain a cotton swab containing extract 3.

The extract 3-adhered tip of the cotton swab was held at the DART-SVP ion source and analyzed by a DART-MS method using DART-SVP (manufactured by Ionsense Inc.)/AccuTOF LC-plus 4G (manufactured by JEOL Ltd.). During analysis, helium gas was used, and the heating temperature was 350° C.

The analysis results are shown in FIG. 2. In FIG. 2, the peak indicated by ▾ is a peak derived from NPE. That is, the peak indicated by ▾ is detected at m/z intervals of about 44, and is thus information from which extract 3 can be determined as containing a compound having a polyoxyalkylene group (a polyoxyethylene group). It is also possible from the resulting information to identify the detected compound as NPE in reference to a known library or the like.

### Example 7

Chlorotrifluoroethylene (CTFE), 2-hydroxyethyl allyl ether (HEAE), isobutyl vinyl ether (IBVE), methyl methacrylate (MMA), and 2-ethylhexyl methacrylate (EHMA) were used as monomers and polymerized in water as a polymerization solvent in the presence of octylphenol ethoxylate (OPE) to give aqueous dispersion 3 containing fluorinated polymer 3 (a fluorinated polymer concentration of 50 mass %, an OPE concentration of 0.05 mass %). Fluorinated polymer 3 was a polymer having a unit derived from CTFE in an amount of 34 mol %, a unit derived from HEAE in an amount of 7 mol %, a unit derived from IBVE in an amount of 9 mol %, a unit derived from MMA in an amount of 41 mol %, and a unit derived from EHMA in an amount of 9 mol % based on all units contained in fluorinated polymer 3.

Aqueous dispersion 4 containing fluorinated polymer 4 (a fluorinated polymer concentration of 50 mass %, a PA concentration of 0.05 mass %) was obtained in the same manner except that PA was used in place of OPE.

Substrates provided with coating films formed from aqueous coating material 3 and aqueous coating material 4 were produced, and extracts of the resulting coating films were analyzed, in the same manner as in Examples 3 to 6 except that aqueous dispersion 3 was used in place of aqueous dispersion 1 and aqueous dispersion 4 was used in place of aqueous dispersion 2. In any of the analyses by a MALDI/TOFMS method and a DART-MS method, results from which it was possible to determine that the extracts contained a compound having a polyoxyalkylene group were obtained.

### Example 8

The resulting extracts were analyzed in the same manner as in Examples 1 to 6 except that CH₃O(CH₂CH₂O)₂CH₃ was used in place of NPE. In any of the analyses by a MALDI/TOFMS method and a DART-MS method, results from which it was possible to determine that the extracts contained a compound having a polyoxyalkylene group were obtained.

### Example 9

Substrates provided with coating films formed from aqueous coating material 5 were produced, and extracts of the resulting coating films were analyzed, in the same manner as in Examples 3 to 6 except that an aqueous dispersion containing a fluorinated polymer (manufactured by Eternal Materials Co., Ltd., product number: 4312) was used in place of aqueous dispersion 1. In any of the analyses by a MALDI/TOFMS method and a DART-MS method, results from which the extracts were determined as containing a compound having a polyoxyalkylene group were obtained. Also, by verifying the obtained results with a known library, it was possible to identify the compound as NPE.

Thus, a compound having a polyoxyalkylene group can be highly sensitively detected by using the analysis method of the present invention. In particular, as shown in FIG. 1 and FIG. 2, the use of the analysis method of the present invention makes it possible to highly sensitively detect the peak of a compound (NPE) having a polyoxyalkylene group without detecting the peak of a compound (PA) that does not have a polyoxyalkylene group, and provide information from which whether the compound having a polyoxyalkylene group is contained can be determined. Moreover, as shown in Examples 5 and 6, the use of the present analysis method enables convenient and prompt provision of information that makes it possible to determine whether an environmentally concerned substance represented by NPE is contained in a coating material and a substrate provided with a coating film formed from the coating material without a complex pretreatment.

### Example 10

Extract P obtained from a sample containing perfluorooctanoic acid (PFOA) was analyzed by the same MALDI/TOFMS method as in Example 5. Measurement results are shown in FIG. 3. In FIG. 3, the peak indicated by ▾ is a peak derived from PFOA. That is to say, the peak indicated by ▾ is at 458.97 in terms of m/z, and is information from which extract P can be determined as containing PFOA.

Therefore, the analysis method of the present invention can also detect perfluorocarboxylic acid represented by perfluorooctanoic acid that is an environmentally concerned substance.

This application is a continuation of PCT Application No. PCT/JP2018/024643, filed on Jun. 28, 2018, which is based upon and claims the benefit of priority from Japanese Patent Application No. 2017-126479 filed on Jun. 28, 2017. The contents of those applications are incorporated herein by reference in their entireties.

What is claimed is:

1. A method for analyzing whether a compound having a polyoxyalkylene group is contained in a sample,
the method comprising directly analyzing the sample by a matrix-assisted laser desorption/ionization method or a DART method to provide information for determining whether the compound having a polyoxyalkylene group is contained.

2. The method according to claim 1, wherein the sample is a coating material or an extract of a coating film formed from the coating material.

3. The method according to claim 2, wherein the coating material is an aqueous coating material containing a fluorinated polymer, water, and the compound having a polyoxyalkylene group, the fluorinated polymer has a unit based on fluoroolefin, and the fluoroolefin is at least one selected from the group consisting of CF₂═CF₂, CF₂═CFCF₃, CF₂═CFCl, CF₂═CH₂, CF₃—CH═CHF, and CF₃—CF═CH₂.

4. The method according to claim 3, wherein the fluorinated polymer has a unit based on a monomer other than the fluoroolefin and copolymerizable with the fluoroolefin.

5. The method according to claim 3, wherein the fluorinated polymer further has a unit having a hydrophilic group.

6. The method according to claim 1, wherein the sample has a content of the compound having a polyoxyalkylene group of 0.0001 to 10 mass %.

7. The method according to claim 1, wherein the compound having a polyoxyalkylene group has a molecular weight of 10,000 or less.

8. The method according to claim 1, wherein the compound having a polyoxyalkylene group is a compound represented by formula (1) below: 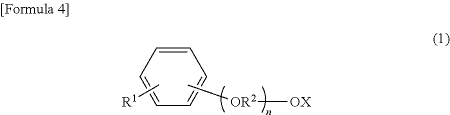
wherein R¹ represents an alkyl group having 1 to 40 carbon atoms, R² represents an alkylene group having 2 to 4 carbon atoms, n represents an integer of 2 or more, and X represents H, SO₃⁻Na⁺, or SO₃⁻NH₄⁺.

9. The method according to claim 8, wherein the compound represented by formula (1) is alkylphenol ethoxylate.

10. The method according to claim 9, wherein the compound represented by formula (1) is nonylphenol ethoxylate or octylphenol ethoxylate.

11. The method according to claim 1, wherein the sample contains perfluorocarboxylic acid as a contaminant, and the method also provides information for determining whether the perfluorocarboxylic acid is contained.

12. The method according to claim 11, wherein the perfluorocarboxylic acid is perfluorooctanoic acid.
